(19) United States
(12) Patent Application Publication
(10) Pub. No.: US 2025/0299253 A1
(43) Pub. Date: Sep. 25, 2025

(54) USER INTERFACE FOR SPEED COMMUNICATIONS

(71) Applicant: Bank of America Corporation, Charlotte, NC (US)

(72) Inventors: Augustin Laruelle, New York, NY (US); Faysal Haouas, New York, NY (US)

(21) Appl. No.: 18/616,067

(22) Filed: Mar. 25, 2024

(51) Int. Cl. G06Q 40/04; G06Q 30/0201; G06Q 30/0601

(52) U.S. Cl. CPC G06Q 40/04; G06Q 30/0201; G06Q 30/0641

(57) ABSTRACT

A user interface operating on a hardware processor and a hardware memory for electronically transacting over-the-counter transactions in multiple partitions, including predetermined windows of time, during a time period is provided. The interface may include an observation display operable to display an observation, every one second, within the windows of time. The windows of time may occur multiple times in one day. The observation may include an observation time plus/minus a fixed observation time quantity. The interface may include an index display that displays, for an index, an index value, based on the observation, including a TWAP. The interface may include a market condition display operable to display a determined market condition. The condition may be determined based on the index price. The interface may include a buy/sell selection button operable to receive a buy/sell indication from a user to buy/sell of one of the transactions based on the condition.

### FIELD OF TECHNOLOGY

Aspects of the disclosure relate to speed communications.

### BACKGROUND OF THE DISCLOSURE

Variance swaps are over-the-counter financial derivatives. Variance swaps enable speculation of, or hedge of risk associated with, the volatility (magnitude of movement), of an underlying instrument, such as a stock index, exchange rate or interest rate. The payout of a variance swap may be linear to variance rather than volatility.

Variance swaps conventionally traded using “close” and exchange delivery settlement price (“EDSP”) observations. EDSP observations may be an observation in the morning. The monthly expires of an index option, such as, for example, the Standard and Poor's index (“SPX”) option, may use this observation to settle. Thus, conventionally variance swaps used the EDSP observation as the last observation. The in-between observations may be the official closing index level.

Conventional trading leads to the inability to get exposure to some market observations and trends, such as intraday realized volatility or intraday momentum. Conventionally, intraday realized volatility was only captured with a single observation during the day. Also, intraday momentum was typically traded with linear payoffs using some signal to trade a delta.

It would be desirable to enable investors to access intraday realized volatility.

It would be further desirable to enable the investors to access intraday realized volatility by providing exposure to the square of the logarithmic intraday returns.

It would be further desirable to provide flexibility in the windows over which the intraday returns are observed. It would be further desirable to provide investors and/or clients with an opportunity to have a customized exposure, preferably periodically, throughout the day.

### SUMMARY OF THE DISCLOSURE

Systems, apparatus and methods for trading zero day to expiry variance swaps are provided. Such systems may leverage the listing and liquidity of short-term options to offer a tailored solution to harvest intraday realized volatility.

Such a system may observe the underlying level multiple times in one day. Multiple observations in a single day may enable exposition to shorter term realized variance and intraday nonlinear momentum.

Such a system may provide the flexibility of time windows on which intraday returns are observed. The cutoff of the observation of the intraday return may be adapted to a client's preference. The cutoff of the return may be at specific intervals during the day. Additionally, the cutoff can be executed prior to trading and/or after trading. In circumstances where the cutoff is executed after trading, the client may provide notice of trading direction prior to execution of actual trading.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows an illustrative diagram in accordance with principles of the disclosure;

FIG. 2 shows another illustrative diagram in accordance with principles of the disclosure;

FIG. 3 shows yet another illustrative diagram in accordance with principles of the disclosure;

FIG. 4 shows still another illustrative diagram in accordance with principles of the disclosure;

FIGS. 5A and 5B show yet another illustrative diagram in accordance with principles of the disclosure; and

FIG. 6 shows still another illustrative diagram in accordance with principles of the disclosure.

### DETAILED DESCRIPTION OF THE DISCLOSURE

Apparatus, methods, systems and user-interfaces for electronically transacting over-the-counter transactions in multiple partitions during a time period is provided. The multiple partitions may include predetermined windows of time.

Methods may include providing an observation. The observation may be provided every one second or at any other suitable time period. The observation may be provided within the predetermined windows of time. The predetermined windows of time may occur multiple times in one day.

The observation may include an observation time plus/minus a fixed observation time quantity. The observation time may be 10:00 AM, 11:00 AM, 12:00 PM, 1:00 PM, 2:00 PM, 3:00 PM or a time customized by a user. The fixed observation time quantity may be two minutes.

Based on the observation, method may include computing an index value for an index. The index value may include a time weighted average price (“TWAP”). The TWAP may be calculated as the arithmetic average of each tick in the index, between observation times minus two minutes and the observation time.

Methods may include determining a market condition for a buyer/seller based on the index price. Methods may include supporting buy/sell of one of the over-the-counter transactions based on the determined market condition.

Methods may include creating a graphical user interface (“GUI”) for a user to buy or sell based on the determined market condition.

Methods may also include providing a user interface (“U”) that displays an instrument identifier, a weight, a total delta in percentage, and/or a total delta in currency amount to be refreshed on a per second basis (and/or any other suitable basis, such as per nanosecond, per minute and/or per hour).

The observation may be provided using a grid comprising two or more processing units. The processing units may include one or more of the following specifications included in Table A and/or Table B.

TABLE A
not less than 640 tensor cores;
not less than 5,120 compute unified device architecture (“CUDA”) cores;
not less than a double precision performance at between 7 and 8.2 trillion floating
point operations per second (“TFLOPS”);
not less than a single precision performance at between 14 and 16.4 TFLOPS;
not less than a tensor performance at between 112 and 130 TFLOPS;
not less than a graphical processing unit (“GPU”) memory at between 32 gigabyte
(“GB”)/16 GB HBM2 (“Second Generation High Bandwidth Memory”) and 32 GB
HBM2;
not less than a memory bandwidth between 900 GB/sec and 1134 GB/sec;
not less than an error correction code (“ECC”) ;
not less than an interconnect bandwidth between 32 GB/sec and 300 GB/sec;
not less than a system interface of peripheral component interconnect express
(“PCIe”) third generation (“Gen3”) and/or a wire-based serial multi-lane near-range
communications link (“NVLink”);
not less than a form factor of PCIe Full Height/Length or a high bandwidth socket
solution (“SXM2”);
not less than a maximum power consumption of between 250 W and 300 W;
not less than a passive thermal solution; and
a plurality of computer application programming interfaces (“APIs”) that support
CUDA (Compute Unified Device Architecture, running compute kernels on general
purpose computing on graphics processing units (“DirectCompute”), a framework for
writing programs that execute across heterogenous platforms (“OpenCL”) and a
programming standard for parallel computing (“OpenACC”).

TABLE B
not less than a double precision floating point format (“FP64”) of 9.7 trillion floating
point operations per second (“TFLOPS”);
not less than a double precision tensor cores (“FP64 Tensor Core”) of 19.5 TFLOPS;
not less than a single precision floating point format (“FP32”) of 19.5 TFLOPS;
not less than a tensor float 32 (“TF32”) of 156 TFLOPS to 312 TFLOPS;
not less than a brain floating point (“BFLOAT16”) of 312 TFLOPS to 624 TFLOPS;
not less than a half precision floating point format (“FP16”) Tensor Core of 312
TFLOPS to 624 TFLOPS;
not less than a INT8 Tensor Core of 624 tera operations per second (“TOPS”) to 1248
TOPS;
not less than a graphical processing unit (“GPU”) memory of 80 GB HBM2e;
not less than a GPU memory bandwidth of 1935 GB/s to 2039 GB/s; and
not less than a maximum thermal design power of 300 Watt (“W”) to 500 W.

Apparatus and methods described herein are illustrative. Apparatus and methods in accordance with this disclosure will now be described in connection with the figures, which form a part hereof. The figures show illustrative features of apparatus and method steps in accordance with the principles of this disclosure. It is to be understood that other embodiments may be utilized and that structural, functional and procedural modifications may be made without departing from the scope and spirit of the present disclosure.

The steps of methods may be performed in an order other than the order shown or described herein. Embodiments may omit steps shown or described in connection with illustrative methods. Embodiments may include steps that are neither shown nor described in connection with illustrative methods.

Illustrative method steps may be combined. For example, an illustrative method may include steps shown in connection with another illustrative method.

Apparatus may omit features shown or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

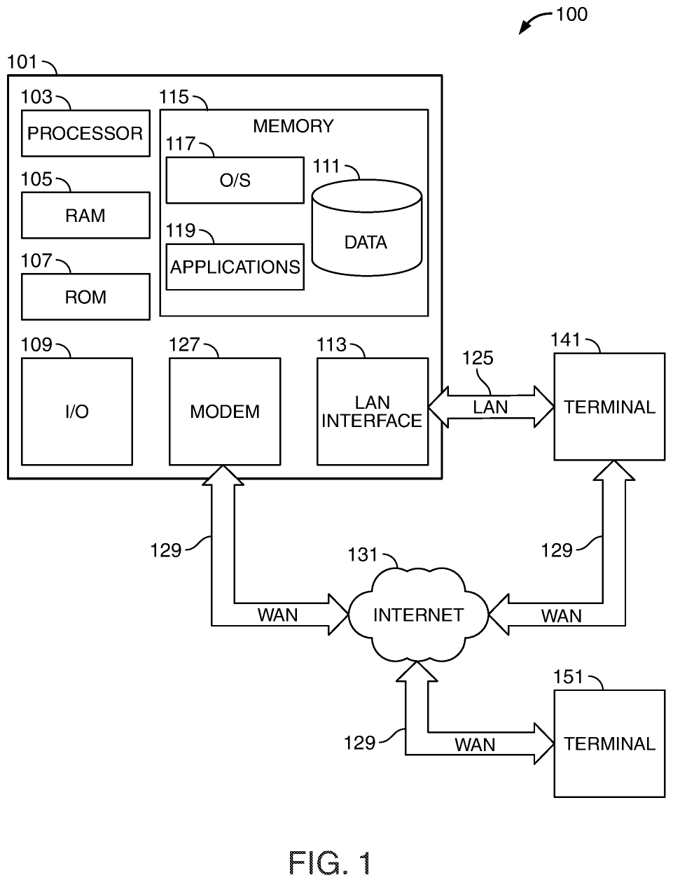

FIG. 1 shows an illustrative block diagram of system 100 that includes computer 101. Computer 101 may alternatively be referred to herein as an “engine,” “server” or a “computing device.” Computer 101 may be a workstation, desktop, laptop, tablet, smart phone, or any other suitable computing device. Elements of system 100, including computer 101, may be used to implement various aspects of the systems and methods disclosed herein. Each of the user telephones, mobile devices, user devices, databases and any other part of the disclosure may include some or all of apparatus included in system 100.

Computer 101 may have a processor 103 for controlling the operation of the device and its associated components and may include Random Access Memory (“RAM”) 105, Read Only Memory (“ROM”) 107, input/output circuit 109 and a non-transitory or non-volatile memory 115. Machine-readable memory may be configured to store information in machine-readable data structures. The processor 103 may also execute all software executing on the computer—e.g., the operating system and/or voice recognition software. Other components commonly used for computers, such as EEPROM or Flash memory or any other suitable components, may also be part of the computer 101.

Memory 115 may be comprised of any suitable permanent storage technology—e.g., a hard drive. Memory 115 may store software including the operating system 117 and application(s) 119 along with any data 111 needed for the operation of the system 100. Memory 115 may also store videos, text and/or audio assistance files. Nodes, servers, computing devices, user telephones, user devices, databases and any other suitable computing devices as disclosed herein may have one or more features in common with Memory 115. The data stored in Memory 115 may also be stored in cache memory, or any other suitable memory.

Input/output (“I/O”) module 109 may include connectivity to a microphone, keyboard, touch screen, mouse and/or stylus through which input may be provided into computer 101. The input may include input relating to cursor movement. The input/output module may also include one or more speakers for providing audio output and a video display device for providing textual, audio, audiovisual and/or graphical output. The input and output may be related to computer application functionality.

System 100 may be connected to other systems via a local area network (“LAN”) interface 113. System 100 may operate in a networked environment supporting connections to one or more remote computers, such as terminals 141 and 151. Terminals 141 and 151 may be personal computers or servers that include many or all of the elements described above relative to system 100. When used in a LAN networking environment, computer 101 is connected to LAN 125 through a LAN interface or adapter 113. When used in a Wide Area Network (“WAN”) networking environment, computer 101 may include a modem 127 or other means for establishing communications over WAN 129, such as Internet 131. Connections between System 100 and Terminals 151 and/or 141 may be used for the communication between different nodes and systems within the disclosure.

It will be appreciated if the network connections shown are illustrative and other means of establishing a communications link between computers may be used. The existence of various well-known protocols such as TCP/IP, Ethernet, FTP, HTTP and the like is presumed, and the system can be operated in a client-server configuration to permit retrieval of data from a web-based server or application programming interface (“API”). Web-based, for the purposes of this application, is to be understood to include a cloud-based system. The web-based server may transmit data to any other suitable computer system. The web-based server may also send computer-readable instructions, together with the data, to any suitable computer system. The computer-readable instructions may be configured to store the data in cache memory, the hard drive, secondary memory, or any other suitable memory.

Additionally, application program(s) 119, which may be used by computer 101, may include computer executable instructions for invoking functionality related to communication, such as e-mail, Short Message Service (“SMS”) and voice input and speech recognition applications. Application program(s) 119 (which may be alternatively referred to herein as “plugins,” “applications,” or “apps”) may include computer executable instructions for invoking functionality related to performing various tasks. Application programs 119 may utilize one or more algorithms that process received executable instructions, perform power management routines or other suitable tasks. Application programs 119 may utilize one or more decisioning processes.

Application program(s) 119 may include computer executable instructions (alternatively referred to as “programs”). The computer executable instructions may be embodied in hardware or firmware (not shown). Computer 101 may execute the instructions embodied by the application program(s) 119 to perform various functions.

Application program(s) 119 may utilize the computer-executable instructions executed by a processor. Generally, programs include routines, programs, objects, components, data structures, etc. that perform particular tasks or implement particular abstract data types. A computing system may be operational with distributed computing environments where tasks are performed by remote processing devices that are linked through a communications network. In a distributed computing environment, a program may be located in both local and remote computer storage media including memory storage devices. Computing systems may rely on a network of remote servers hosted on the Internet to store, manage and process data (e.g., “cloud computing” and/or “fog computing”).

Any information described above in connection with data 111 and any other suitable information, may be stored in memory 115. One or more of applications 119 may include one or more algorithms that may be used to implement features of the disclosure comprising the transmission, storage, and transmitting of data and/or any other tasks described herein.

The invention may be described in the context of computer-executable instructions, such as applications 119, being executed by a computer. Generally, programs include routines, programs, objects, components, data structures, etc., that perform particular tasks or implement particular data types. The invention may also be practiced in distributed computing environments where tasks are performed by remote processing devices that are linked through a communications network. In a distributed computing environment, programs may be located in both local and remote computer storage media including memory storage devices. It should be noted that such programs may be considered for the purposes of this application, as engines with respect to the performance of the particular tasks to which the programs are assigned.

Computer 101 and/or terminals 141 and 151 may also include various other components, such as a battery, speaker and/or antennas (not shown). Components of computer system 101 may be linked by a system bus, wirelessly or by other suitable interconnections. Components of computer system 101 may be present on one or more circuit boards. In some embodiments, the components may be integrated into a single chip. The chip may be silicon-based.

Terminal 151 and/or terminal 141 may be portable devices such as a laptop, cell phone, tablet, smartphone, or any other computing system for receiving, storing, transmitting and/or displaying relevant information. Terminal 151 and/or terminal 141 may be one or more data sources or a calling source. Terminals 151 and 141 may have one or more features in common with apparatus 101. Terminals 115 and 141 may be identical to system 100 or different. The differences may be related to hardware components and/or software components.

The invention may be operational with numerous other general purpose or special purpose computing system environments or configurations. Examples of well-known computing systems, environments and/or configurations that may be suitable for use with the invention include, but are not limited to, personal computers, server computers, hand-held or laptop devices, tablets, mobile phones, smart phones and/or other personal digital assistants (“PDAs”), multiprocessor systems, microprocessor-based systems, cloud-based systems, programmable consumer electronics, network PCs, minicomputers, mainframe computers, distributed computing environments that include any of the above systems or devices and the like.

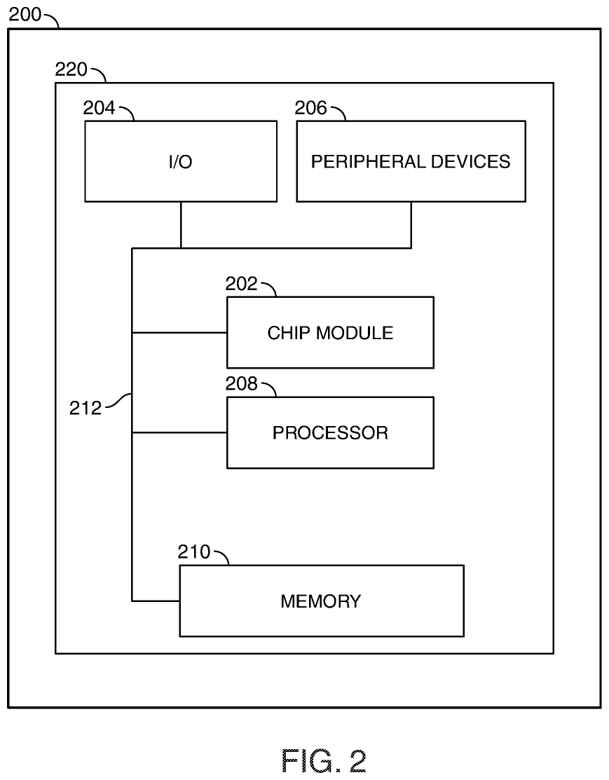

FIG. 2 shows illustrative apparatus 200 that may be configured in accordance with the principles of the disclosure. Apparatus 200 may be a computing device. Apparatus 200 may include one or more features of the apparatus shown in FIG. 1. Apparatus 200 may include chip module 202, which may include one or more integrated circuits, and which may include logic configured to perform any other suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device or any other suitable media or devices; peripheral devices 206, which may include counter timers, real-time timers, power-on reset generators or any other suitable peripheral devices; logical processing device 208, which may compute data structural information and structural parameters of the data; and machine-readable memory 210.

Machine-readable memory 210 may be configured to store in machine-readable data structures: machine executable instructions, (which may be alternatively referred to herein as “computer instructions” or “computer code”), applications such as applications 119, signals and/or any other suitable information or data structures.

Components 202, 204, 206, 208 and 210 may be coupled together by a system bus or other interconnections 212 and may be present on one or more circuit boards such as 220. In some embodiments, the components may be integrated into a single chip. The chip may be silicon-based.

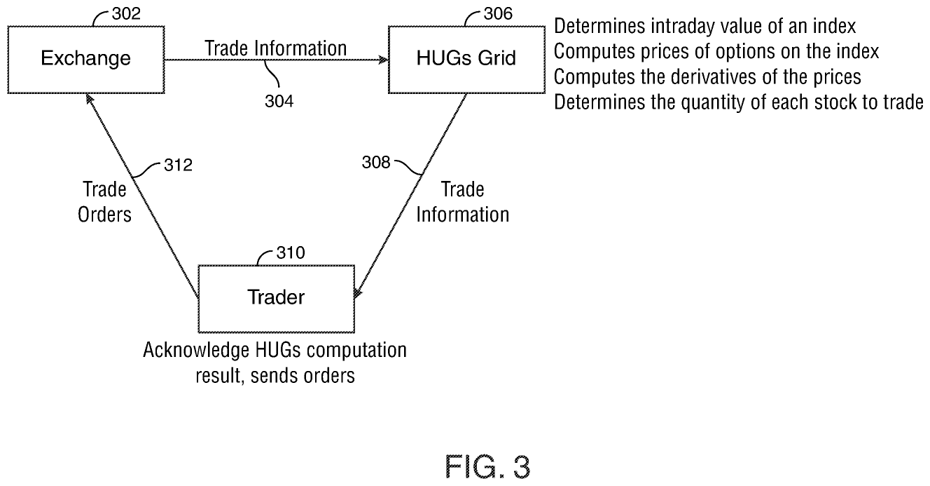

FIG. 3 shows an illustrative diagram. Exchange 302 may be an exchange where stockbrokers and traders can buy and sell securities, such as shares of stock, bonds and other financial instruments.

Exchange 302 may provide trade information 104 with HUGs grid 306. HUGs may be a distributed programming platform and custom grid scheduler. The HUGs platform may include three primary components: 1. Client, 2. Scheduler and 3. Nodeservice and nodes.

The client may include Python code. The client may be responsible for creating the task structure, serialization of parameters and/or sending the task over to the HUGs scheduler. The client may also collect the final result by polling the HUGs scheduler in a loop.

The scheduler may be a component of the HUGs grid. Clients may submit their tasks to the scheduler. The scheduler may, in turn, schedule the tasks to connected nodes. The scheduler may collect the results of the tasks from the connected nodes. The scheduler may pass the results back to the client.

The nodeservice may run on one, more than one and/or substantially every engine of the grid. At times, each engine of the grid may be and/or include a node. Nodes may be identified as hardware components and/or software components. The nodeservice may be responsible for creating nodes.

HUGs grid 306 may be, in one embodiment, a computer cluster comprised of multiple servers running a majority of NVIDIA Tesla A100 and V100 Tensor Core graphical processing units (“GPUs”). The speed information of one GPU for the A100 INT8 Tensor Core is approximately 1248 trillion floating point operations per second (“TFLOPS”). The speed information of one GPU for the V100 Tensor Performance is approximately 130 TFLOPS.

HUGs grid 306 may determine an intraday value of an index. HUGs grid 306 may compute prices of options on the index. HUGs grid 306 may compute the derivatives of the prices. The derivatives of the prices may be volatility derivates of options. It should be noted that options may be derivates of stocks. Based on the determination of the intraday value, the computed prices and/or the derivatives of the prices, HUGs grid 306 may determine the quantity of each stock to trade during the windows of trading. The quantity of each stock to trade may be identified as trade information, as shown at 308.

HUGs grid 106 may transmit the determined trade information 308 to trader 310. Trader 310 may include one or more computers specialized for trading. The computers specialized for trading may include one or more of the above-mentioned GPUs (NVIDIA Tesla A100 and V100 Tensor Core). Trader 310 may acknowledge the HUGs computation result. Based on the HUGs computation, trader 310 may create trade orders 312. Trade orders 312 may be transmitted to exchange 302.

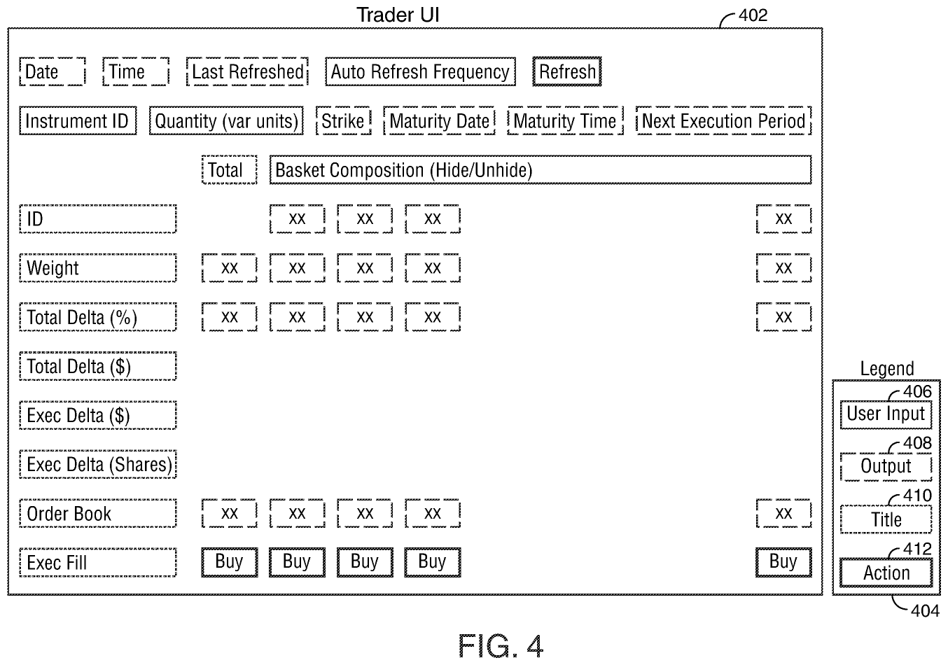

FIG. 4 shows an illustrative diagram. The illustrative diagram shows a trader user interface (“UI”) 402. Trader UI 402 may be displayed on a screen of a computing device, such as, for example, a workstation, a laptop, a smartphone, or any other suitable computing device.

Trader UI 402 includes various functions. Each of the functions may be a user input function, output function, title function, action function and/or any other suitable function. Legend 404 indicates the use of each function. Trader UI 402 may include user input functions, indicated at 406, output functions, indicated at 408, title functions, indicated at 410 and action functions, indicated at 412.

Trader UI may include the following user input functions: auto refresh frequency, instrument identifier (“ID”), quantity (variance (“var”) units) and basket composition (hide/unhide).

The auto refresh frequency function may enable a user to specify, or a system to set, a frequency in which trader UI is refreshed.

The instrument identifier may enable a user to specify, or a system to set, a tradable instrument or security. The identifier may ensure that the buyer and seller are referring to the same instrument while trading. Identifiers may include tickers, international securities identification numbers (“ISIN”), committee on uniform securities identification procedures (“CUSIP”), stock exchange daily official list (“SEDOL”), financial instrument global identifier (“FIGI”), market identifier code (“MIC”) and legal entity identifier (“LEI”).

The quantity in variance units may be a multiplier to the quantity of the tradable instruments.

The basket composition may be a portfolio of instruments traded on an exchange. The portfolio may be known as exchange-traded funds and may be designed to track the performance of a particular index. The composition of the basket may be determined by an exchange-traded funds issuer. The exchange-traded funds issuer may be responsible for selecting the securities included in the basket. The basket composition may show each instrument within the basket and associated information. Hide/Unhide may enable a trader to view multiple securities and their associated data or the total group of the securities and their associated data.

The outputs may include date, time, last refreshed, strike, maturity date, maturity time, next execution period and others.

The date may be the current date. The time may be the current time.

The “last refreshed” indicator may identify the last time that trader UI was refreshed.

Strike may be a price at which the holder of an instrument, such as an option, can exercise the option to buy or sell an underlying instrument, such as a security.

Maturity date may be the last day on which an instrument, such as an option, can be exercised (either bought or sold) into the underlying instrument, such as a security.

Maturity time may be the last time (within the maturity date) in which the instrument, such as an option, can be exercised (either bought or sold) into the underlying instrument, such as a security.

Next execution period may be a time period when a trader may need to re-hedge the trader's position to match the trades economics.

Title functions of the trader UI are shown as total, identifier (“ID”), weight, total delta (in percent), total delta (in dollar amount), exec delta (in dollar amount), exec delta (in shares), order book and exec fill.

The order book may be a list of orders that a trading venue uses to record the interest of buyers and sellers in a particular financial instrument. A machine-based matching engine may use the order book to determine which orders can be fully or partially executed.

The delta of an option is a measure of how much the option's price is expected to change in response to a one-dollar movement in the underlying asset.

Total delta of the security may be shown in percentage and in dollar amount.

Exec delta, as shown in a dollar amount, exec delta, as shown in shares and/or exec fill may also be shown. Exec delta, as shown in a dollar amount, may be the delta to buy/sell to get to the total delta by already taking into account the delta in the book. Exec delta, as shown in shares, may be same information as the exec delta, shown in a dollar amount, however, it may be displayed as a number of shares and not a dollar amount. Exec fill may be a row of buttons with an action that may trade the exec delta using the order book.

The action functions may include a refresh function and a buy function. The refresh function may be a request to refresh trader UI. The buy function may be a request to buy a specific instrument, such as an option. The buy option may be executed for a specific instrument, for a basket of instruments or for a portion of an entirety of an exchange.

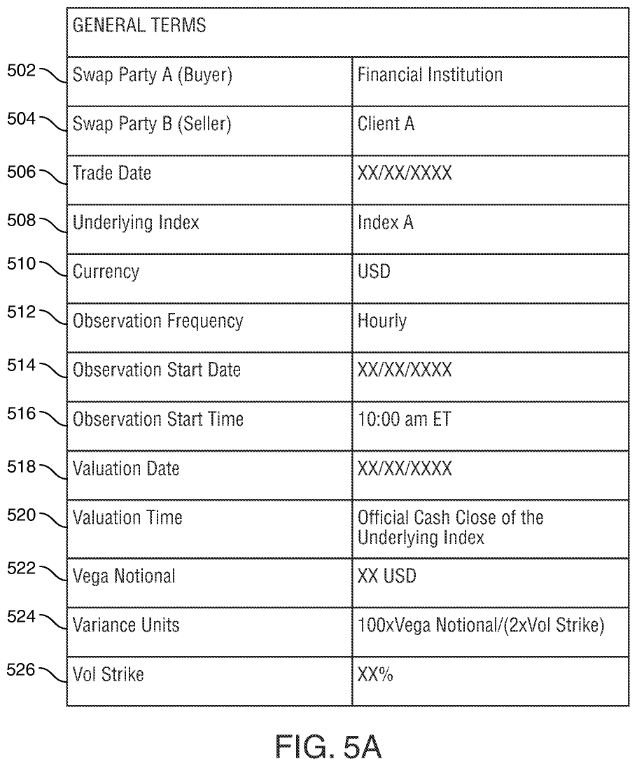

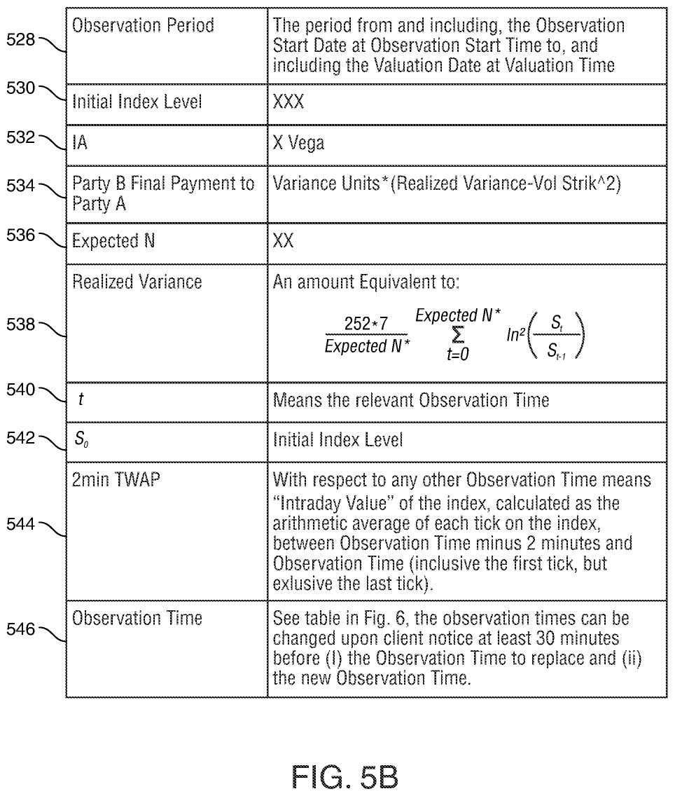

FIGS. 5A and 5B show an illustrative diagram. The illustrative diagram shows a general term sheet which begins on FIG. 5A and continues onto FIG. 5B.

It should be noted that the term “X” may be used in the term sheet to identify values that may be filled in a trade-by-trade basis.

General terms may include a swap party A (buyer), as shown at 502. The swap party A may be a financial institution.

General terms may include a swap party B (seller), as shown at 504. The swap party B may be a client, such as client A.

General terms may include a trade date, as shown at 506. The trade date may be shown as XX/XX/XXXX.

General terms may include an underlying index, as shown at 508. The underlying index may be any suitable index, such as Index A.

General terms may include a currency, as shown at 510. The currency may be United States Dollars (USD) or any other suitable currency.

General terms may include an observation frequency, shown at 512. The observation frequency may be a time frequency at which a price of instrument is observed. The observation frequency may be hourly or any other suitable frequency.

General terms may include an observation start date, as shown at 514. The observation start date may be a date on which the observation begins. The observation start date may be shown as XX/XX/XXXX.

General terms may include an observation start time, as shown at 516. The observation start time may be a time at which the observations are scheduled to begin. The observation start time may be 10:00 AM ET.

General terms may include a valuation date, as shown at 518. The valuation date may be date on which an instrument was evaluated for a specific currency value. The valuation date may be shown at XX/XX/XXXX.

General terms may include a valuation time, as shown at 520. The valuation time may be the official cash close of the underlying index. The underlying index may be Index A, shown at 508.

General terms may include a Vega notional, as shown at 522. The Vega notional may represent the expected profit and loss of a variance swap for a one percent change in volatility from the strike price. Vega notional may enable assessment of the magnitude of the trade. For example, with a Vega notional of $10,000, a one-point difference in volatility may result in a profit or loss close to $10,000. The Vega notional may be an amount shown in a currency. As such, XX USD may represent the amount of the Vega notional.

General terms may include variance units, as shown at 524. The variance units may be a unit of variance. The variance unit may be calculated as (100 multiplied by Vega Notional) divided by (2 multiplied by Vol Strike).

General terms may include volatility strike, as shown at 526. Volatility strike may be a percentage amount at which the instrument may be sold. Volatility strike may be displayed as a percentage. As such, Volatility strike may be shown at XX %.

General terms may include an observation period, as shown at 528. Observation period may be the period from and including the observation start date at observations start time to, and including, the valuation date at valuation time.

General terms may include an initial index level, as shown at 530. The initial index level may be the closing level of the instrument at the observation start date at the observation start time. The initial index level may be shown at XXX.

General terms may include an initial amount (“IA”), as shown at 532. The IA may be shown as X Vega. The IA may be quoted as a multiplier to the Vega Notional. For example, if the Vega Notional is $100,000.00 United States Dollars and the IA is 1.5 Vega, then the IA is $150,000.00 United States Dollars.

General terms may include a final payment from party B to party A, as shown at 534. It should be noted that it may be difficult to determine the final payment amount at least because the underlying trading instrument is not a cash-based trading instrument, rather a trading instrument that is a derivative (variance swap) of a derivative (option) of a cash-based trading instrument. As such, the formula for identifying the final payment may be variance units multiplied by (realized variance minus vol strike to the power of two).

General terms may include expected N, as shown at 536. The expected N may be shown as XX. The expected N may be the expected number of windows. The expected number of windows may determine the expected number of returns that are being observed. There may be seven observations of TWAPs which enables the observation of six returns.

General terms may include realized variance, as shown at 538. The realized variance may include an equation that identifies an amount of money that a first party (either party A or party B) owes to a second party (either party A or party B). The equation states to observe the level of the underlying every second over the two minutes (included in a TWAP) every hour. The equation will view the specific performance from hour to hour over the TWAP (time weighted average price). The equation will view the performance of the index from TWAP to TWAP. The performance of the index from TWAP to TWAP will be input into a logarithmic function to identify a logarithmic return. The output of the logarithmic function will be squared to identify the payoff. The log squared returns will be added over the different periods of observation.

In order to change the equation from an hourly perspective to an annual perspective, the numbers 252 and 7 may be incorporated. The number 252 may account for a normalized number to identify the return as an annual return as opposed to a daily return. The number 7 may account for a normalized to identify the return as a daily return as opposed to an hourly return. The number 7 may be composed of two parts. A first part may be 6.5 hours of trading hours during the day and 0.5 hours of trading to account for the overnight trading hours. As such, the equation may show the perspective in terms of a year instead of in terms of an hour.

The summation may be used to sum up the number of windows. St may be the value of TWAP at time 1. St−1 may be the value of TWAP at the most recent time.

It should be noted that the realized variance may stay fairly stable at around +−0.5% return, however, the realized variance may be viewed as an exponential function at around +−2% return.

General terms may include t, as shown at 540. t may be understood to mean the relevant observation time.

General terms may include S0. S0 may be understood to mean the initial index level.

General terms may include a 2 min TWAP, as shown at 544. The 2 min TWAP may be understood to mean with respect to any other observation time, the “Intraday Value” of the index. The observation time may be calculated as the arithmetic average of each tick on the index, between observation time minus two minus and observation time (inclusive of first tick but exclusive of last tick).

General terms may include an observation time, as shown at 546. The observation times may be around the hour. However, the observation times may be changed upon client notice at least 30 minutes before the observation time to replace and the new observation time.

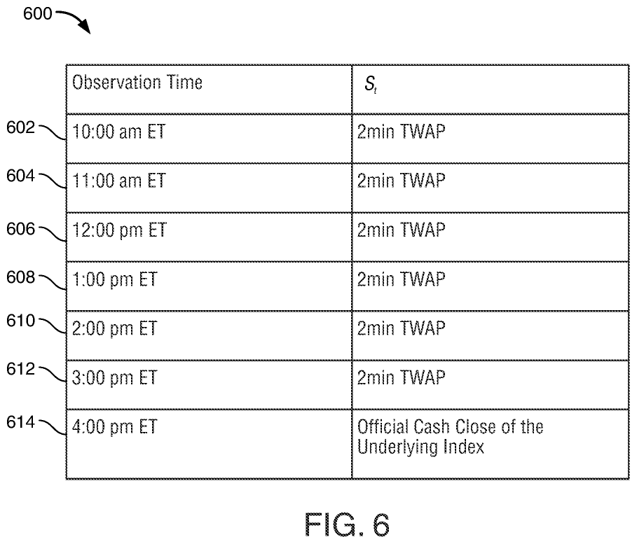

FIG. 6 shows an illustrative diagram. The illustrative diagram shows table 600 which includes observation times and initial index levels. The observation times may be at 10:00 AM ET, as shown at 602, 11:00 AM ET, as shown at 604, 12:00 PM ET, as shown at 606, 1:00 PM ET, as shown at 608, 2:00 PM ET, as shown at 610, 3:00 PM ET, as shown at 612 and 4:00 PM ET, as shown at 614. Each observation time may be associated with an initial index level as indicated by a 2 min TWAP. It should be noted that 4:00 PM ET may be the official cash close of the underlying index for the day. It should also be noted that a trader may be required to trade every one second during the two-minute time window in order to complete the trading task.

Thus, systems and methods for electronically transacting over-the-counter transactions in multiple partitions during a time period are provided. Persons skilled in the art will appreciate that the present invention can be practiced by other than the described embodiments, which are presented for purposes of illustration rather than of limitation. The present invention is limited only by the claims that follow.

What is claimed is:

1. A method for electronically transacting over-the-counter transactions in multiple partitions during a time period, said multiple partitions comprising predetermined windows of time, the method comprising:
providing an observation, every one second, within the predetermined windows of time, said predetermined windows of time occurring multiple times in one day, said observation comprising an observation time plus/minus a fixed observation time quantity;
based on the observation, computing an index value for an index, said index value comprising a time weighted average price (“TWAP”);
determining a market condition for a buyer/seller based on the index value; and
supporting buy/sell of one of the over-the-counter transactions based on the determined market condition.

2. The method of claim 1 further comprising creating a graphical user interface (“GUI”) for a user to buy or sell based on the determined market condition.

3. The method of claim 1 wherein the observation time is at least one of 10:00 AM, 11:00 AM, 12:00 PM, 1:00 PM, 2:00 PM or 3:00 PM.

4. The method of claim 3 wherein the fixed observation time quantity is two minutes.

5. The method of claim 1 wherein the observation is provided using a grid comprising two or more processing units.

6. The method of claim 5 wherein the processing units include one or more of the following specifications:
not less than 640 tensor cores;
not less than 5,120 compute unified device architecture (“CUDA”) cores;
not less than a double precision performance at between 7 and 8.2 trillion floating point operations per second (“TFLOPS”);
not less than a single precision performance at between 14 and 16.4 TFLOPS;
not less than a tensor performance at between 112 and 130 TFLOPS;
not less than a graphical processing unit (“GPU”) memory at between 32 gigabyte (“GB”)/16 GB HBM2 (“Second Generation High Bandwidth Memory”) and 32 GB HBM2;
not less than a memory bandwidth between 900 GB/sec and 1134 GB/sec;
not less than an error correction code (“ECC”);
not less than an interconnect bandwidth between 32 GB/sec and 300 GB/sec;
not less than a system interface of peripheral component interconnect express (PCIe) third generation (“Gen3”) and/or a wire-based serial multi-lane near-range communications link (“NVLink”);
not less than a form factor of PCIe Full Height/Length or a high bandwidth socket solution (“SXM2”);
not less than a maximum power consumption of between 250 W and 300 W;
not less than a passive thermal solution; and
a plurality of computer application programming interfaces (“APIs”) that support CUDA (Compute Unified Device Architecture, running compute kernels on general purpose computing on graphics processing units (“DirectCompute”), a framework for writing programs that execute across heterogenous platforms (“OpenCL”) and a programming standard for parallel computing (“OpenACC”).

7. The method of claim 1 wherein the TWAP is calculated as an arithmetic average of each tick in the index, between observation times minus two minutes and the observation time.

8. The method of claim 5 wherein the processing units include one or more of the following specifications:
not less than a double precision floating point format (“FP64”) of 9.7 trillion floating point operations per second (“TFLOPS”);
not less than a double precision tensor cores (“FP64 Tensor Core”) of 19.5 TFLOPS;
not less than a single precision floating point format (“FP32”) of 19.5 TFLOPS;
not less than a tensor float 32 (“TF32”) of 156 TFLOPS to 312 TFLOPS;
not less than a brain floating point (“BFLOAT16”) of 312 TFLOPS to 624 TFLOPS;
not less than a half precision floating point format (“FP16”) Tensor Core of 312 TFLOPS to 624 TFLOPS;
not less than a INT8 Tensor Core of 624 tera operations per second (“TOPS”) to 1248 TOPS;
not less than a graphical processing unit (“GPU”) memory of 80 GB HBM2e;
not less than a GPU memory bandwidth of 1935 GB/s to 2039 GB/s; and
not less than a maximum thermal design power of 300 Watt (“W”) to 500 W.

9. The method of claim 1 further comprising providing a user interface (“UI”) that displays an instrument identifier, a weight, a total delta in percentage, a total delta in currency amount to be refreshed on a per second basis.

10. A user interface operating on a hardware processor in combination with a hardware memory for electronically transacting over-the-counter transactions in multiple partitions during a time period, said multiple partitions comprising predetermined windows of time, the user interface comprising:
an observation display operable to display an observation, every one second, within the predetermined windows of time, said predetermined windows of time occurring multiple times in one day, said observation comprising an observation time plus/minus a fixed observation time quantity;
an index display operable to display an index value for an index, said index value being computed for the index based on the observation, said index value comprising a time weighted average price (“TWAP”);
a market condition display operable to display a determined market condition, said determined market condition being determined for a buyer/seller based on the index value; and
a buy/sell selection button operable to receive a buy/sell indication from a user to buy/sell of one of the over-the-counter transactions based on the determined market condition.

11. The user interface of claim 10 wherein the observation time is at least one of 10:00 AM, 11:00 AM, 12:00 PM, 1:00 PM, 2:00 PM or 3:00 PM.

12. The user interface of claim 11 wherein the fixed observation time quantity is two minutes.

13. The user interface of claim 10 wherein the observation is provided using a grid comprising two or more processing units.

14. The user interface of claim 13 wherein the processing units include one or more of the following specifications:
not less than 640 tensor cores;
not less than 5,120 compute unified device architecture (“CUDA”) cores;
not less than a double precision performance at between 7 and 8.2 trillion floating point operations per second (“TFLOPS”);
not less than a single precision performance at between 14 and 16.4 TFLOPS;
not less than a tensor performance at between 112 and 130 TFLOPS;
not less than a graphical processing unit (“GPU”) memory at between 32 gigabyte (“GB”)/16 GB HBM2 (“Second Generation High Bandwidth Memory”) and 32 GB HBM2;
not less than a memory bandwidth between 900 GB/sec and 1134 GB/sec;
not less than an error correction code (“ECC”);
not less than an interconnect bandwidth between 32 GB/sec and 300 GB/sec;
not less than a system interface of peripheral component interconnect express (PCIe) third generation (“Gen3”) and/or a wire-based serial multi-lane near-range communications link (“NVLink”);
not less than a form factor of PCIe Full Height/Length or a high bandwidth socket solution (“SXM2”);
not less than a maximum power consumption of between 250 W and 300 W;
not less than a passive thermal solution; and
a plurality of computer application programming interfaces (“APIs”) that support CUDA (Compute Unified Device Architecture, running compute kernels on general purpose computing on graphics processing units (“DirectCompute”), a framework for writing programs that execute across heterogenous platforms (“OpenCL”) and a programming standard for parallel computing (“OpenACC”).

15. The user interface of claim 10 wherein the TWAP is calculated as an arithmetic average of each tick in the index, between observation times minus two minutes and the observation time.

16. The user interface of claim 13 wherein the processing units include one or more of the following specifications:
not less than a double precision floating point format (“FP64”) of 9.7 trillion floating point operations per second (“TFLOPS”);
not less than a double precision tensor cores (“FP64 Tensor Core”) of 19.5 TFLOPS;
not less than a single precision floating point format (“FP32”) of 19.5 TFLOPS;
not less than a tensor float 32 (“TF32”) of 156 TFLOPS to 312 TFLOPS;
not less than a brain floating point (“BFLOAT16”) of 312 TFLOPS to 624 TFLOPS;
not less than a half precision floating point format (“FP16”) Tensor Core of 312 TFLOPS to 624 TFLOPS;
not less than a INT8 Tensor Core of 624 tera operations per second (“TOPS”) to 1248 TOPS;
not less than a graphical processing unit (“GPU”) memory of 80 GB HBM2e;
not less than a GPU memory bandwidth of 1935 GB/s to 2039 GB/s; and
not less than a maximum thermal design power of 300 Watt (“W”) to 500 W.

17. The user interface of claim 10 further comprising an instrument identifier, a weight, a total delta in percentage, a total delta in currency amount to be refreshed on a per second basis.

18. The user interface of claim 10 wherein the user interface is refreshed at least every one second.
